(19) United States
(12) Patent Application Publication
(10) Pub. No.: US 2013/0311558 A1
(43) Pub. Date: Nov. 21, 2013

(54) PROFILE-BASED WIRELESS SENSOR NETWORK SYSTEM AND COMMUNICATION METHOD

(71) Applicant: ELECTRONICS AND TELECOMMUNICATIONS RESEARCH INSTITUTE, (US)

(72) Inventors: Kwang Soo KIM, Daejeon (KR); Tae-Wook HEO, Daejeon (KR); Hyunhak KIM, Daejeon (KR); Jongjun PARK, Daejeon (KR); Kyeseon LEE, Daejeon (KR); Yoonmee DOH, Daejeon (KR); Jong-Arm JUN, Daejeon (KR)

(73) Assignee: ELECTRONICS AND TELECOMMUNICATIONS RESEARCH INSTITUTE, Daejeon (KR)

(21) Appl. No.: 13/728,195

(22) Filed: Dec. 27, 2012

(30) Foreign Application Priority Data
May 21, 2012 (KR) 10-2012-0053871

(51) Int. Cl. H04L 29/06

(52) U.S. Cl. CPC H04L 65/403
USPC 709/204

(57) ABSTRACT

In a sensor network system including at least one sensor node and at least one actuator node, a group is formed based on attribute of each node. Sensing data is shared among the nodes in the group, and each node performs autonomous processing to process an event by comparing the sensing data with a preset event threshold value.

### CROSS-REFERENCE TO RELATED APPLICATION

This application claims priority to and the benefit of Korean Patent Application No. 10-2012-0053871 filed in the Korean Intellectual Property Office on May 21, 2012, the entire contents of which are incorporated herein by reference.

### BACKGROUND OF THE INVENTION

(a) Field of the Invention

The present invention relates to a wireless sensor network, and more particularly, to a wireless sensor network system and a communication method which are based on a profile.

(b) Description of the Related Art

Wireless sensor networks include a plurality of sensor nodes and actuator nodes. In a wireless sensor network, the sensor nodes transmit collected or generated information (e.g., temperature, humidity, illumination, electricity use, etc.) to a server through wireless communication in order to provide meaningful information to a network user. Moreover, the network user analyzes the information collected from the sensor nodes through the server, selects actuator nodes requiring control, and sends control commands (e.g., switch on/off, air conditioner temperature control, fan switch on/off) to selected actuators. The actuator nodes change the environment by executing a received control command. One of the most popular methods to perform such a process is a centralized data collection method. In this method, a single data collection server is used, and all nodes send data they have generated to the data collection server.

The most important issue in such a wireless sensor network is to increase the lifetime of the sensor nodes/actuator nodes. In general, nodes have a small size and operate on a battery. Thus, the operation time of the nodes is very limited. Also, when power supply from the battery is stopped, this may have an effect on the overall operation of the sensor, as well as stopping the operation of the nodes. In the centralized data collection method, however, nodes in the vicinity of the data collection server consume a huge amount of power compared to other nodes, and hence their operation is stopped quickly.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a profile-based wireless sensor network system and communication method which can reduce the amount of data transmission depending on autonomous processing by each node in a wireless sensor network.

An exemplary embodiment of the present invention provides a communication method in a wireless sensor network including at least one node. The method may use attributes. The attribute of a node may be the type of sensor (e.g., temperature, humidity, light, etc.) installed on the node and that of an actuator node is the type of accuator (e.g., switch on/off, etc.). The method includes transmitting, by a first node, a message containing information of a first node to a neighboring second node; receiving, by the first node, profile information containing attributes of the second node from the second node; transmitting, by the first node, a group join request message to the second node if an attribute of the first node is identical to that of the second node; and joining, by the first node, the group to which the second node belongs based on a response message from the second node.

The attribute may be about the type of sensing data collected by each node. In this method, nodes having the same attribute constitute a single group, and nodes in the group exchange information among themselves.

Another embodiment of the present invention provides a communication method in a wireless sensor network including at least one node. The method includes acquiring, by a first node, sensing data; comparing, by the first node, the sensing data with a preset event threshold value; and if a value of the sensing data is greater than the threshold value, determining, by the first node, that an event has occurred and notifying a second node belonging to the same group about the occurrence of the event. The group includes nodes having the same attribute, and nodes in the same group are notified about the occurrence of the event.

The notifying may include selecting, by the first node, the second node which is a destination node to be notified about the occurrence of the event when an event occurs; and sending, by the first node, an event notification message containing at least one of event occurrence data, sensing data, and a control command corresponding to the event, to the second node. The first node may be a sensor node that performs a sensing operation and acquires sensing data, and the second node may be an actuator node that performs an actuation function corresponding to the event.

The method may further include at least one of extracting, by the second node, the control command contained in the event occurrence message and performing an actuation function according to the control command; performing, by the second node, a preset actuation function for the corresponding event in response to an event occurrence notification contained in the event occurrence message; and determining, by the second node, whether an event has occurred by comparing the sensing data contained in the event occurrence message with a preset event threshold value, and if an event has occurred, performing, by the second node, an actuation function corresponding to the event.

The method may further include modifying the profile of a node, including modifying the event threshold value. The modifying of the profile may include receiving, by the first node, a profile modification message containing a modified event threshold value from other nodes belonging to the same group having the same attribute; and modifying, by the first node, the event threshold value of the first node in accordance with the event threshold value contained in the profile modification message. The profile modification message is transmitted from an actuator node in the group to which the first node belongs.

Yet another embodiment of the present invention provides a wireless sensor network system including a plurality of sensor nodes and a plurality of actuator nodes, wherein at least one sensor node and at least one actuator node which have the same attribute constitute a single group, and the attribute is the type of sensing data collected by each node.

The sensor node and the actuator node determine whether an event has occurred based on a preset event threshold value and acquired sensing data, and if an event has occurred, reports to the nodes in the same group about the occurrence of the event, and the actuator node performs an actuation function corresponding to the event.

A further exemplary embodiment of the present invention provides a node device, which constitutes a wireless sensor network, the node device including: a dynamic group management unit that dynamically creates a group of nodes having the same attribute; a profile management unit that stores and manages profile information containing an event threshold value; and a data and event processing unit that sets an event threshold value in accordance with the profile information, compares acquired sensing data with the threshold value, and if an event has occurred, notifies the nodes of the group to which the corresponding node belongs about the occurrence of the event and performs an actuation function corresponding to the event.

The dynamic group management unit may include: a dynamic group creation and control module that dynamically creates, deletes, and controls a group based on attribute containing the profile set for the node and the type of sensor installed at the node; and a dynamic binding module which performs information exchange between groups.

The profile management unit may include: a profile definition and distribution module that defines details of the profile set for the corresponding node and sends the corresponding profile to neighboring nodes, and sends a profile modification message containing modified profile information to neighboring nodes of the corresponding group; and a profile update and multiprofiling module that updates the profile managed by the profile definition and distribution module based on an update stored in a message received from a remote location.

The data and event processing unit may include: a sensing data acquisition module that acquires sensing data; an event setup module that sets up an event to be executed based on the sensing data and sets a threshold value for the setup event; and an event processing and linking module that determines whether an event has occurred by comparing the acquired sensing data with the threshold value for the event, and notifies other nodes of the same group about the occurrence of the event.

### BRIEF DESCRIPTION OF THE DRAWINGS

FIG. 1 is a view showing a structure of a wireless sensor network system.

FIG. 2 is a view showing a structure of a wireless sensor network system according to an exemplary embodiment of the present invention.

FIG. 3 is an illustration showing the classification of nodes into groups according to an exemplary embodiment of the present invention.

FIG. 4 is a flowchart of a communication method for forming a group in a sensor network according to an exemplary embodiment of the present invention.

FIG. 5 is a flowchart showing an operating process of a node in a sensor network according to an exemplary embodiment of the present invention.

FIG. 6 is an illustration showing a profile modification process of nodes according to an exemplary embodiment of the present invention.

FIG. 7 is a view showing a structure of a node according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements.

Hereinafter, a profile-based wireless sensor network system and communication method according to an exemplary embodiment of the present invention will be described with reference to the drawings.

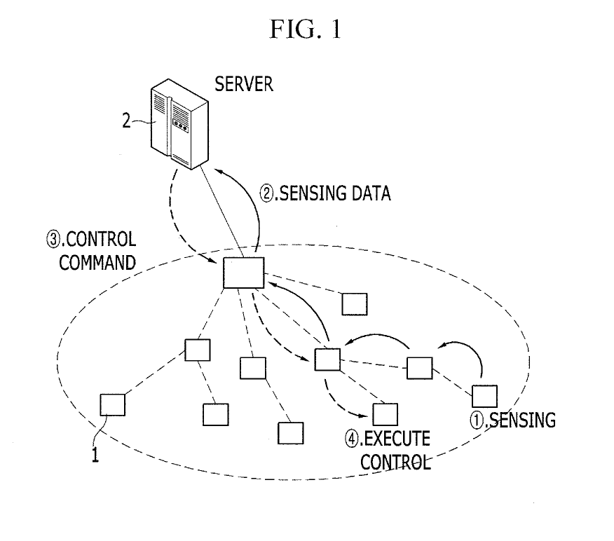

FIG. 1 is a view showing a structure of a wireless sensor network system.

As shown in the accompanying FIG. 1, in general, all nodes 1 in a wireless sensor network system send generated data to a data collection server 2 existing on a network. The data collection server 2 analyzes data collected from each node and generates an event based on a result of the analysis. Next, it selects nodes to process the event, and sends a control command to the selected nodes. On receiving the control command, the nodes perform an operation corresponding to the received control command.

In order to carry out such a process, all the nodes 1 send information they have collected to the data collection server 2, and this requires more data movement paths and results in an increase in the battery consumption of the nodes. Therefore, the lifetime of the nodes and the sensor network is shortened, and more data loss is caused by an increase in data traffic.

In the exemplary embodiment of the present invention, each of the nodes of the wireless sensor network performs autonomous processing. The autonomous processing refers to letting the nodes sense data and determine whether to execute an event based on the sensed data, and process the event based on a result of the determination. The autonomous processing can be performed by forming a group based on a profile.

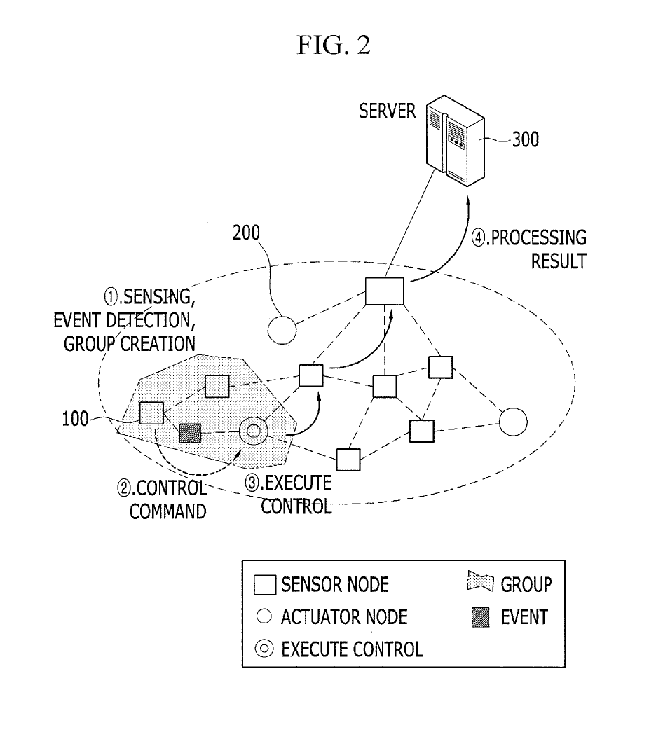

FIG. 2 is a view showing a structure of a wireless sensor network system according to an exemplary embodiment of the present invention.

As shown in the accompanying FIG. 2, the wireless sensor network system according to the exemplary embodiment of the present invention includes a plurality of sensor nodes 100, a plurality of actuator nodes 200, and a server 300.

The plurality of sensor nodes 100 generate sensing data, and the sensing data may include temperature, humidity, illuminance, etc., of the surrounding environment, for example. Each sensor node includes a sensor, and the sensor is used to monitor the environment and generate sensing data.

The plurality of actuator nodes 200 perform a predetermined operation, i.e., an actuation function, in response to a control command. The actuation function may include functions for controlling the environment, such as power on/off, window open/close, etc., for example. The nodes exchange information based on a wireless communication technology, e.g., ZigBee, and can be connected to the server 300 through a gateway (not shown). The server 300 is capable of performing the function of receiving information from the nodes and processing it.

In the exemplary embodiment of the present invention, each node constitutes a group based on the profile. The profile includes attribute of each node. The attribute can be classified according to the characteristics of the sensing data. For example, if the sensing data is “temperature”, sensor nodes associated with temperature sensing data and actuator nodes performing the actuator function (e.g., a function of controlling temperature of the surrounding environment, including heater on/off, air conditioner on/off, etc.) associated with temperature may be included in a single group. The attribute of a sensor node may be the type of sensing data the sensing node can sense (e.g., temperature, humidity, illuminance, CO, CO₂, PIR (pyroelectric infrared rays), etc.).

The attribute of an actuator node may be on a type of actuator (e.g., electric switch on/off actuator, window open/close actuator, door lock/unlock actuator, etc.) which can be controlled by the actuator node. The sensing data and the actuation function are closely associated with each other. Thus, an event is executed based on this association. For example, when some condition is met, such as when a room temperature increases to a certain temperature or higher, or when the room CO₂ increases to a certain level or higher, a window opening event is executed. Therefore, sensor nodes and actuator nodes having the same or similar attributes based on the attribute of the sensor nodes and the attribute of the actuator nodes may be formed as a single group.

A group including at least one sensor node and at least one actuator node can be formed based on the attribute of each node.

Each of the nodes sends sensing data they have collected to a predetermined destination through an information exchange with neighboring nodes located within their communication range. To this end, criteria for generating an event and a threshold value for the event are preset for each node. Accordingly, if each node determines that an event has occurred after comparing sensing data it has obtained with a set threshold value, it transmits event occurrence data, sensing data, or a control command to a destination node. The destination node may be an actuator node. The actuator node compares and analyzes its set threshold values based on information collected by itself or information collected from neighboring nodes, and performs an appropriate actuator function. The threshold values set for each node may be remotely modified by changing the profile.

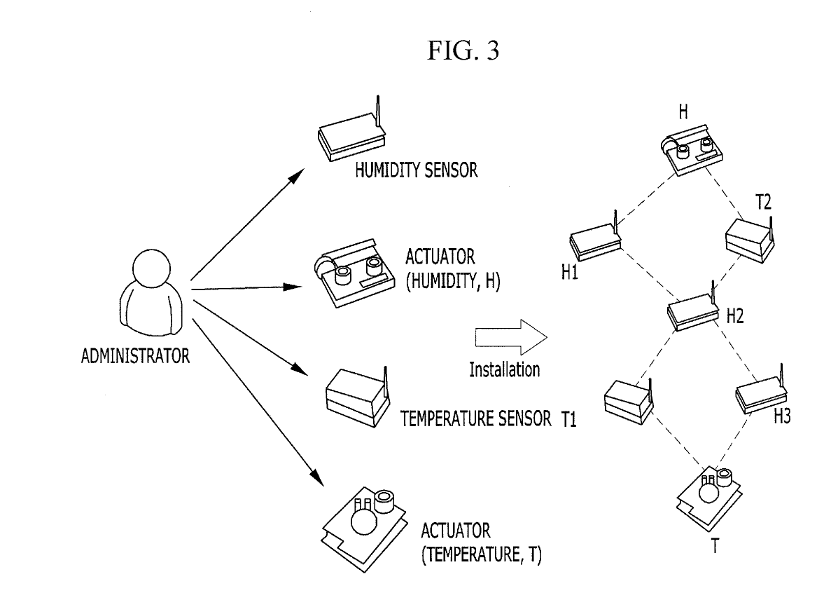

FIG. 3 is an illustration showing the classification of nodes into groups according to an exemplary embodiment of the present invention.

As shown in FIG. 3, in a wireless sensor network in which a plurality of nodes having different attribute are distributed, nodes having the same attribute constitute a single group. In FIG. 3, the administrator can set a profile with attribute for each node. The profile may include an event type and information related to each event. Nodes H, H1, H2, and H3 have attribute related to a humidity sensor and constitute a first group, and nodes T, T1, T2, and T3 have attribute related to a temperature sensor and constitute a second group.

As a group is formed based on attribute, the distance between nodes of the same group is not affected by the communication range of each node. For example, as shown in FIG. 3, sensor node H3, which is located closer to actuator node T than to actuator node H is included in the first group based on the attribute. Also, sensor node T2, which is located closer to the actuator node H than to the actuator node T, is included in the second group based on the attribute.

In general, a group or cluster can be formed based on the position of a node and the radio transmission distance of a node. In this case, nodes included in the same group or cluster are included within the communication range of each group/cluster. Moreover, nodes in a group or cluster also include nodes having different attributes. Thus, upon processing an inquiry, the inquiry is also sent to nodes not related to the inquiry, and this may cause a huge amount of communication traffic.

In the exemplary embodiment of the present invention, all nodes in a group have the same attribute. Thus, upon processing an inquiry, the inquiry is sent only to nodes related to the inquiry, and therefore communication traffic during the inquiry processing can be reduced. Moreover, when a new node is added to the sensor network, this node sends its information to neighboring nodes. On receiving this information, an actuator node transmits its profile to the newly added node, and the node compares the received profile with its profile and joins the corresponding group.

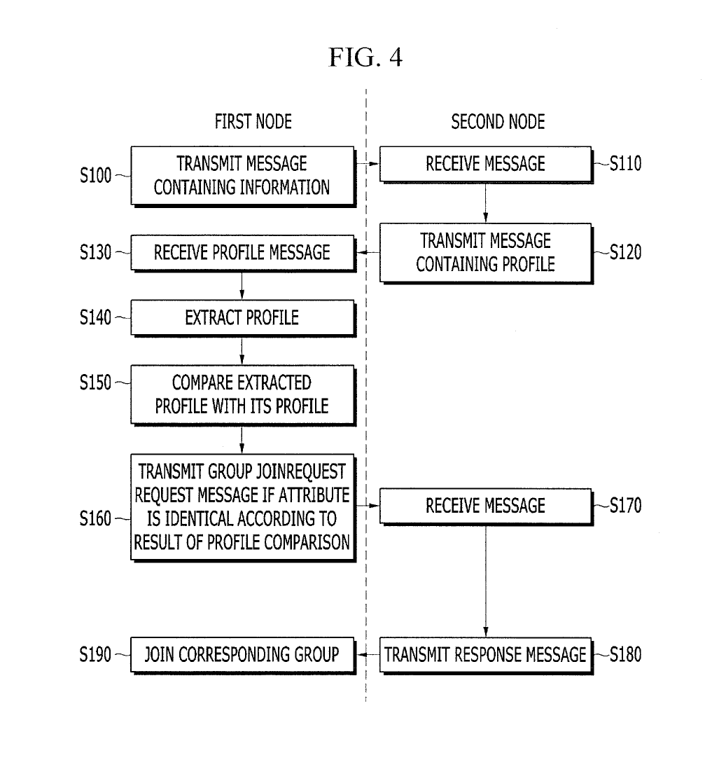

FIG. 4 is a flowchart of a communication method for forming a group in a sensor network according to an exemplary embodiment of the present invention.

As shown in the accompanying FIG. 4, a first node transmits a message containing its information to neighboring nodes (S100). On receiving the message containing the information of the first node, a second node, which is a neighboring node, transmits a message containing its profile information to the first node (S110 and S120).

The first node receives the message containing the profile from the second node, and extracts the profile of the second node from the received message and compares it with its profile (S130 to S150).

As a result of the profile comparison, if their attribute is identical, the first node transmits a group join request message to the second node (S160). The group join request message may include attribute of the first node.

When the group join request message is transmitted from the first node (S170), the second node transmits a group join response message to the first node (S180). If the attribute of the first node contained in the group join request message is identical to attribute of the corresponding group, the second node may transmit a response message to the first node permitting the first node to join the group.

On receiving the response message, the first node joins the group of the second node (S190).

By this process, nodes having the same attribute constitute a single group. Nodes in a single group can store and manage information of the nodes in the group.

The nodes constituting the group as above perform autonomous processing to send event occurrence information to the nodes in the same group.

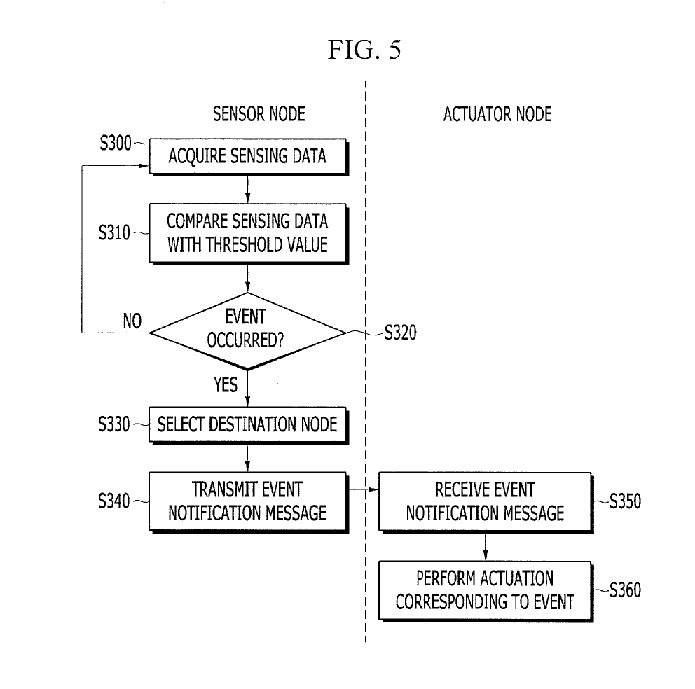

FIG. 5 is a flowchart showing an operating process of a node in a sensor network according to an exemplary embodiment of the present invention.

The nodes store and manage their profile, and information such as an event to be executed by each node, a threshold value related to the event, etc. is preset, stored, and managed in the nodes.

Each of the nodes may send sensing data they have collected to a desired destination through an information exchange with neighboring nodes located within their communication range. More specifically, as shown in FIG. 5, a certain node, for example, a sensor node, acquires sensing data by performing a sensing operation (S300), and compares the acquired sensing data with a preset event threshold value (S310).

If a sensing value corresponding to the acquired sensing data is greater than the event threshold value, the sensor node considers that the event has occurred (S320). For example, if a measured temperature is higher than a set temperature, it is determined that a temperature control event has occurred.

When an event occurs, the sensor node selects a destination node (e.g., actuator node performing temperature control) which is to send event occurrence information (S330), and sends an event notification message containing at least one of event occurrence data, sensing data, and a control command corresponding to the event (S340) to a destination node.

Hereupon, the sensor node may select an actuator node included in the group it belongs to, and transmit the event notification message to the actuator node, which is the destination, via the nodes in the group. For example, in such a sensor network as shown in FIG. 3 where groups are formed, if humidity, which is sensing data acquired by a sensing operation, exceeds a preset event threshold value, the sensor node H3 for measuring humidity generates an event occurrence message and transmits it to the actuator node H, which is a destination node. The event occurrence message may be transmitted to the actuator node H, which is the destination, via other nodes H2 and H1 included in the first group.

Meanwhile, on receiving the event occurrence message, the actuator node performs an actuation function (e.g., function for humidity control) corresponding to the occurred event, as shown in FIG. 5 (S350 and S360). For example, the actuator node extracts the control command contained in the event occurrence message, and performs an actuation function according to the control command. Alternatively, the actuator node performs a preset actuation function for the corresponding event in response to an event occurrence notification contained in the event occurrence message. Alternatively, the actuator node compares the sensing data contained in the event occurrence message with a preset event threshold value, determines which event has occurred, and performs an actuation function corresponding to the event.

Such an actuator node is able to performing an appropriate actuation function by analyzing multiple information sets contained in the event occurrence message and collected from neighboring nodes.

The threshold values set for the sensor node and the actuator node can be modified by a profile modification process. Such a modification process can be remotely performed.

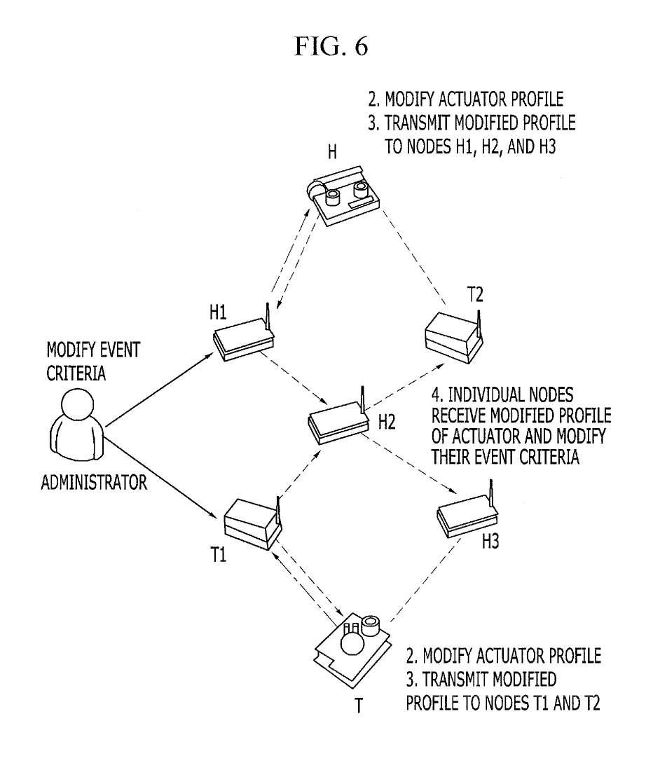

FIG. 6 is an illustration showing a profile modification process of nodes according to an exemplary embodiment of the present invention.

As illustrated in FIG. 6, a threshold value which serves as criteria for an event is preset for each node, and each node is installed at a desired position.

When it is desired to modify, i.e., update a profile containing an event threshold value set for each node, it is conventionally difficult to actually apply the modified threshold value to the node. Specifically, when it is desired to modify a threshold value of a node, the node to be modified needs to be removed from its installation position before the threshold value of the node is modified, and thereafter the node needs to be installed to its original position. This makes the modification of the threshold value difficult and inconvenient. Moreover, even when a group is formed based on distance or position, nodes to perform a relevant event need to be detected. Thus, a huge amount of traffic is caused by the process of sending information for the modification of the threshold value, which is complicated.

According to the exemplary embodiment of the present invention, however, since nodes in the same group have the same attribute, the nodes in the same group send information for event update to each other, thereby making it easy to modify a profile containing an event threshold value of each node.

For example, as exemplified in FIG. 6, when it is desired to modify event criteria for a predetermined group, a profile containing an event threshold value of the actuator node H included in the first group is modified. Once the profile is modified, the actuator node H included in the first group transmits a profile modification message containing the modified event threshold value to each of the nodes belonging to its group. The profile modification message is sent to each of the nodes H1, H2, and H3 of the first group. The actuator node T included in the second group also transmits a profile modification message containing the modified event threshold value to each of the nodes belonging to its group once the profile is modified. The profile modification message is sent to each of the nodes T1, T2, and T3 of the second group. Upon receiving the profile modification message of each group, each of the nodes modifies the stored event threshold value based on the threshold value contained in the message.

Accordingly, the administrator can easily modify the profiles of other nodes having the same attribute as the corresponding actuator node merely by modifying the profile of the actuator node. In the above example, of course, the profile of a sensor node instead of an actuator node of a predetermined group may be modified, and the sensor node may send a profile modification message to other nodes including the actuator node of the group so that each node modifies its profile.

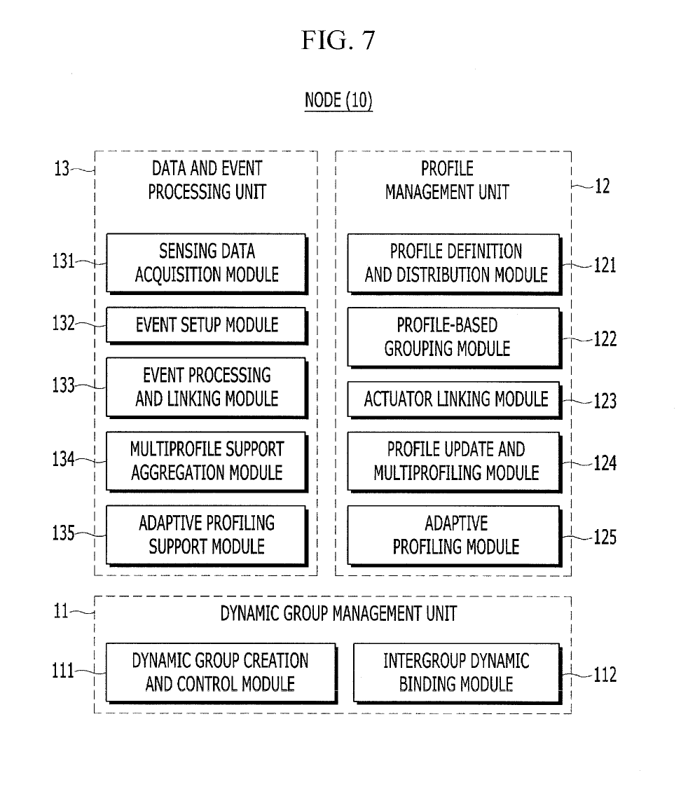

FIG. 7 is a view showing a structure of a node according to an exemplary embodiment of the present invention, which depicts a structure of a sensor node and of an actuator node according to an exemplary embodiment of the present invention.

As shown in the accompanying FIG. 7, a node (which is denoted by reference numeral 10 for convenience of description) according to an exemplary embodiment of the present invention includes a dynamic group management unit 11, a profile management unit 12, and a data and event processing unit 13.

The dynamic group management unit 11 dynamically creates, deletes, and manages a group of nodes having the same attribute. To this end, the dynamic group management unit 11 includes a dynamic group creation and control module 111 which dynamically creates, deletes, and controls a group based on attribute containing the profile set for the node and the type of sensor installed at the node, and a dynamic binding module 112 which performs information exchange between groups.

The profile management unit 12 stores and manages the profile for the corresponding node. To this end, the profile management unit 120 includes a profile definition and distribution module 121 and a profile-based grouping module 123. Further, the profile management unit 120 includes an actuator linking module 124, a profile update and multiprofiling module 125, and an adaptive profiling module 126.

The profile definition and distribution module 121 defines the details of the profile set for the corresponding node and sends the corresponding profile to neighboring nodes. Especially in the case that the profile is modified, a profile modification message containing modified profile information (e.g., event threshold value, etc) is sent to neighboring nodes of the corresponding group.

The profile-based grouping module 123 controls the dynamic group management unit 122 so as to create a group according to the details defined in the profile.

The actuator linking module 124 provides a control command conforming to the applied wireless communication method (e.g., ZigBee) to an actuator node. The actuator linking module 124 may send a control command in accordance with the ZigBee smart energy specification, and operate based on SE so that the actuator node performs a control command.

The profile update and multiprofiling module 125 enables automatic modification of the profile installed at a node from a remote location. That is, the profile update and multiprofiling module 125 updates the profile managed by the profile definition and distribution module 121 based on an update stored in a message received from a remote location. Moreover, the profile update and multiprofiling module 125 performs a multiprofiling function of processing a plurality of profiles.

The adaptive profiling module 126 adaptively modifies the details of the profile of a sensor node based on the cumulative distribution of sensing values of sensing data generated by the node without network user's interference.

The data and event processing unit 13 acquires sensing data and processes an event according to the sensing data. To this end, the data and event processing unit 130 includes a sensing data acquisition module 131, an event setup module 131 for setting up an event and setting a threshold value for the event, and an event processing and linking module 133. Besides, the data and event processing unit 130 further includes a multiprofiling support module 134 and an adaptive profiling support module 135.

If the corresponding node is a sensor node, the sensing data acquisition module 131 acquires sensing data, which is a sensing value sensed by each sensor of the sensor node. If the corresponding node is an actuator node, the sensing data acquisition module 131 acquires sensing data from a message sent from other nodes.

The event setup module 132 sets up an event to be executed based on the sensing data, and sets a threshold value for the setup event.

The event processing and linking module 133 determines whether an event has occurred by comparing the sensing data with the threshold value for the event, and notifies other nodes of the same group event about the occurrence of the event. In the case of a sensor node, when an event occurs, at least one destination node, for example, at least one certain actuator node, which is to perform an actuation function for the event, is selected, and a corresponding control command is sent to the selected actuator node. If the corresponding node is an actuator node, the event processing and linking module 133 sends a control command to the actuator linking module 124 so that the actuator linking module 124 performs a relevant actuation function. Moreover, even when there are a plurality of actuator nodes for executing an event, the event processing and linking module 133 sends a control command to each of the plurality of actuator nodes.

The multiprofiling support module 134 provides an aggregation function for processing data and events created by one or more profiles.

The adaptive profiling support module 135 supports adaptive profiling which is generated by a node itself by data analysis.

According to an exemplary embodiment of the present invention, a wireless sensor network is formed based on the profile of each node, and each node of the wireless sensor network transmits data collected by autonomous processing, thereby reducing the amount of data transmission.

Particularly, the cost required for processing an inquiry between nodes can be reduced by creating an attribute-based group. Moreover, data transmission traffic generated in the sensor network can be greatly reduced by transmitting a sensing value generated by a sensor node to a neighboring actuator node having the same attributes as the sensor node, rather than to a centralized server. As a result, the operation time of the sensor node and the sensor network can be extended.

Furthermore, event criteria can be easily modified in a variety of applications that each node constituting the wireless sensor network executes.

The exemplary embodiments of the present invention may also be implemented by a program realizing functions corresponding to the construction of the embodiment, and a recording medium on which the program is recorded, other than the apparatus and/or method described above. Such implementation may be easily made from the disclosure of the above embodiments by those skilled in the art.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication method in a wireless sensor network comprising at least one node, the method comprising:
transmitting, by a first node, a message containing information of a first node to a neighboring second node;
receiving, by the first node, profile information containing attribute of the second node from the second node;
transmitting, by the first node, a group join request message to the second node if attribute of the first node is identical to attribute of the second node; and
joining, by the first node, the group to which the second node belongs based on a response message from the second node.

2. The method of claim 1, wherein the attribute is about the type of sensing data collected by each node.

3. The method of claim 1, wherein nodes having the same attribute constitute a single group, and nodes in the group exchange information.

4. A communication method in a wireless sensor network comprising at least one node, the method comprising:
acquiring, by a first node, sensing data;
comparing, by the first node, the sensing data with a preset event threshold value; and
determining, by the first node, that an event has occurred if the value of the sensing data is greater than the threshold value, and notifying a second node belonging to the same group about the occurrence of the event,
wherein the group comprises nodes having the same attribute, and nodes in the same group are notified about the occurrence of the event.

5. The method of claim 4, wherein the notifying comprises
when an event occurs, selecting, by the first node, the second node, which is a destination node to be notified about the occurrence of the event; and
sending, by the first node, an event notification message containing at least one of event occurrence data, sensing data, and a control command corresponding to the event to the second node.

6. The method of claim 5, wherein the first node is a sensor node that performs a sensing operation and acquires sensing data, and the second node is an actuator node that performs an actuation function corresponding to the event.

7. The method of claim 5, wherein the notifying comprises at least one of extracting, by the second node, the control command contained in the event occurrence message and performing, by the second node, an actuation function according to the control command; performing, by the second node, a preset actuation function for the corresponding event in response to an event occurrence notification contained in the event occurrence message; and determining, by the second node, whether an event has occurred by comparing the sensing data contained in the event occurrence message with a preset event threshold value, and if an event has occurred, performing, by the second node, an actuation function corresponding to the event.

8. The method of claim 4, further comprising modifying the profile of a node, including modifying the event threshold value.

9. The method of claim 8, wherein the modifying comprises
receiving, by the first node, a profile modification message containing a modified event threshold value from other nodes belonging to the same group having the same attribute; and
modifying, by the first node, the event threshold value of the first node in accordance with the event threshold value contained in the profile modification message.

10. The method of claim 9, wherein the profile modification message is transmitted from an actuator node in the group to which the first node belongs.

11. A wireless sensor network system comprising:
a plurality of sensor nodes; and
a plurality of actuator nodes,
wherein at least one sensor node and at least one actuator node which have the same attribute constitute a single group, and
the attribute is the type of sensing data collected by each node.

12. The wireless sensor network system of claim 11, wherein
the sensor node and the actuator node determine whether an event has occurred based on a preset event threshold value and acquired sensing data, and if an event has occurred, reports to the nodes in the same group about the occurrence of the event, and
the actuator node performs an actuation function corresponding to the event.

13. A node device, which constitutes a wireless sensor network, the node device comprising:
a dynamic group management unit that dynamically creates a group of nodes having the same attribute;
a profile management unit that stores and manages profile information containing an event threshold value; and
a data and event processing unit that sets an event threshold value in accordance with the profile information, compares acquired sensing data with the threshold value, and if an event has occurred, notifies the nodes of the group to which the corresponding node belongs about the occurrence of the event and performs an actuation function corresponding to the event.

14. The node device of claim 13, wherein the dynamic group management unit comprises:
a dynamic group creation and control module that dynamically creates, deletes, and controls a group based on attribute containing the profile set for the node and the type of sensor installed at the node; and
a dynamic binding module which performs information exchange between groups.

15. The node device of claim 13, wherein the profile management unit comprises:
a profile definition and distribution module that defines details of the profile set for the corresponding node and sends the corresponding profile to neighboring nodes, and sends a profile modification message containing modified profile information to neighboring nodes of the corresponding group; and
is a profile update and multiprofiling module that updates the profile managed by the profile definition and distribution module based on an update stored in a message received from a remote location.

16. The node device of claim 13, wherein the data and event processing unit comprises:
a sensing data acquisition module that acquires sensing data;
an event setup module that sets up an event to be executed based on the sensing data and sets a threshold value for the setup event; and
an event processing and linking module that determines whether an event has occurred by comparing the acquired sensing data with the threshold value for the event, and notifies other nodes of the same group about the occurrence of the event.
